(19) United States
(12) Patent Application Publication
(10) Pub. No.: US 2023/0351478 A1
(43) Pub. Date: Nov. 2, 2023

(54) MULTI-INSTANCE, MULTI-USER ORDERING METHOD AND SYSTEM

(71) Applicant: WHO'S SHOUT PTY LTD, Parramatta, New South Wales (AU)

(72) Inventors: Anthony ELLIS, Parramatta, New South Wales (AU); John KASBARIAN, Parramatta, New South Wales (AU); Steven CURRAN, Parramatta, New South Wales (AU); Howard BEALE, Parramatta, New South Wales (AU)

(21) Appl. No.: 17/905,585

(22) PCT Filed: Mar. 2, 2021
(86) PCT No.: PCT/AU2021/050178

§ 371 Date: Sep. 2, 2022

(30) Foreign Application Priority Data
Mar. 3, 2020 (AU) 2020900640

(51) Int. Cl. G06Q 30/0601; G06Q 20/14; G06Q 50/12

(52) U.S. Cl. CPC G06Q 30/0635; G06Q 20/14; G06Q 50/12

(57) ABSTRACT

Disclosed herein are a system for automatically managing payments across multiple orders placed by multiple users associated with an ordering group, each user associated with a payment method. The system includes: a venue computing device coupled to a communications network, the venue computing device being associated with a venue; and a database server coupled to the communications network. The database server is adapted to: store a user profile for each of said multiple users, each user profile storing at least one payment method for the respective user; and manage a list of multiple users associated with a shout, the database server including a scheduler adapted to sort the multiple users into an ordered list, based on an order in which the users joined the shout, said scheduler identifying in turn a current host responsible for a next order.

### RELATED APPLICATION

This application is related to Australian Provisional Patent Application No. 2020900640 titled “Multi-instance, multi-user ordering method and system” and filed 3 Mar. 2020 in the name of Who's Shout Pty Ltd, the entire content of which is incorporated by cross-reference as if fully set forth herein.

### TECHNICAL FIELD

The present disclosure relates to a method and system for managing and scheduling multiple orders from multiple users. In particular, the present disclosure relates to a multi-instance, multi-user ordering method and system, such as may be useful in the hospitality industry.

### BACKGROUND

Commercial transactions are typically performed between a single vendor and a single consumer. The vendor offers a range of one or more products from which the consumer can select. The consumer places an order with the vendor by nominating the product or products that the consumer would like to purchase and the quantity of each product. The consumer pays for the order and the order is filled by the vendor.

Historically, commercial transactions were made in person, with the vendor and consumer present at the same time to negotiate the transaction. Later, mail order catalogues enabled consumers to purchase from vendors remotely by sending in paid money orders, credit card details, or the like, or by placing an order over the telephone. In more recent times, the Internet has enabled commercial transactions to occur using computing devices to exchange transaction details over one or more communications media.

In the vast majority of cases, commercial transactions are one-time purchases, in which a consumer purchases one or more products from a vendor. However, there are some situations in which consumers place repeat orders with vendors, wherein the same products are ordered periodically. Such repeat orders are often in relation to consumable products that need replacing at a predictable rate or cycle. Examples of repeat orders may include, for example, a repeat food order from a grocery store, a repeat pet food order from a pet food store, or a repeat stationery order from a stationery store. Further, there are many instances in which a consumer will make multiple orders from a vendor over time, although the orders may be for different products.

Many online websites offer a consumer the option of registering with the website in order to facilitate multiple orders by the consumer over time. When a consumer registers with the website, the website stores information pertaining to the consumer. Such information may include, for example, the name, address, and credit card details associated with the consumer. When the consumer visits the website at a later date, the consumer needs only to log on using the registration details and the stored information is retrieved by the website, thus enabling the consumer to perform a transaction quickly and accurately.

As discussed above, commercial transactions are typically between a single consumer and a single vendor. When a group of people go out for dinner, for example, the restaurant will typically issue a single bill for the group and it is up to the group to collect the appropriate funds to settle the bill. Some establishments will allow such groups to split the bill, wherein the group nominates who is paying for different portions of the overall bill. Splitting bills in this manner is a tedious manual exercise and requires the establishment to perform multiple individual transactions that combine to meet the original bill. Thus, a single commercial transaction is effectively broken into multiple commercial transactions and human intervention is required to effect those transactions.

Existing point of sale (POS) terminals are programmed to handle individual transactions, as described above. POS terminals are not programmed to handle situations in which multiple people, as a group, perform multiple purchases and wish to have the costs associated with the multiple purchases distributed across the people. Thus, there is a technical problem of how to automate a system so as to handle multiple orders relating to a group of multiple users, whilst providing options as to how payments are to be allocated across individual orders or across multiple orders.

Thus, a need exists to provide an improved method and system for automatically managing multiple commercial transactions performed by multiple people over time.

### SUMMARY

The present disclosure relates to a multi-instance, multi-user ordering method and system. The system is suitable for handling multiple orders placed by multiple related users over time.

A first aspect of the present disclosure provides a system for automatically managing payments across multiple orders placed by multiple users associated with an ordering group, each user associated with a payment method, the system comprising:
a venue computing device coupled to a communications network, the venue computing device being associated with a venue; and
a database server coupled to the communications network, said database server adapted to:
   store a user profile for each of said multiple users, each user profile storing at least one payment method for the respective user;
   manage a list of multiple users associated with a shout, the database server including a scheduler adapted to sort the multiple users into an ordered list, based on an order in which the users joined the shout, said scheduler identifying in turn a current host responsible for a next order; and
   for each of a set of orders placed by said multiple users in said shout:
      receive an order associated with the shout for products to be provided by the venue, the received order being associated with a current host;
      charge said current host in accordance with a payment method associated with the user corresponding to the current host;
      forward the received order associated with the shout to the venue computing device for completion by the venue;
      update said list of multiple users to identify a next user in said list as a current host responsible for a next order; and
      notify the current host that the order is ready, based on a communication from the venue.

A second aspect of the present disclosure provides a database server coupled to a communications network, said database server adapted to:
store a user profile for each of a plurality of registered users, each user profile storing at least one payment method for the respective user;
manage a list of multiple users associated with a shout, the database server including a scheduler adapted to sort the multiple users into an ordered list, based on an order in which the users joined the shout, said scheduler identifying in turn a current host responsible for a next order;
for each of a set of orders placed by said multiple users in said shout:
   receive an order associated with the shout for products to be provided by a venue, the received order being associated with a current host;
   charge said current host in accordance with a payment structure associated with that shout;
   forward the received order associated with the shout to a venue computing device for completion by the venue;
   update said list of multiple users to identify a next user in said list as a current host responsible for a next order; and
   notify the current host that the order is ready, based on a communication from the venue.

According to another aspect, the present disclosure provides an apparatus for implementing any one of the aforementioned methods.

According to another aspect, the present disclosure provides a computer program product including a computer readable medium having recorded thereon a computer program that when executed on a processor of a computer implements any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a schematic representation of a system on which one or more embodiments of the present disclosure may be practised;

FIG. 2 is a flow diagram of a method for managing multiple orders from multiple users, in accordance with one or more embodiments of the present disclosure;

FIG. 3 is a schematic block diagram representation of a system that includes a general purpose computer on which one or more embodiments of the present disclosure may be practised;

FIG. 4 is a screenshot of a landing page;

FIG. 5 is a screenshot of a registration page;

FIGS. 6A-B are screenshots of payment setup pages;

FIG. 7 is a screenshot of a “Get Started” page;

FIG. 8 is a screenshot of a page to establish a shout;

FIG. 9 is a screenshot of an active shout screen;

FIG. 10 is a screenshot of an active shout screen;

FIG. 11 is a screenshot of a drinks list screen;

FIG. 12 is a screenshot of a drinks options screen;

FIG. 13 is a screenshot of an order summary screen;

FIG. 14 is a screenshot of a screen indicating that an order is ready;

FIG. 15 is a screenshot of a user profile screen;

FIG. 16 is a schematic block diagram representation of a system that includes a general smartphone on which one or more embodiments of the present disclosure may be practised; and

FIG. 17 is a schematic block diagram representation of an ordered sequence of participants in a group shout, stored as a circular linked list.

Method steps or features in the accompanying drawings that have the same reference numerals are to be considered to have the same function(s) or operation(s), unless the contrary intention is expressed or implied.

### DETAILED DESCRIPTION

The present disclosure provides a system and associated method for handling multiple orders made by a group of related users, wherein the users are associated with each order. The system provides an interface between each of the users and a vendor with which orders are to be placed.

The system utilises a scheduler to manage automatically the responsibility of payment for each order by defining an ordered sequence of the users in the group, storing the ordered sequence in a computer readable storage medium in an appropriate data structure, such as a circular linked list. In some embodiments, the scheduler nominates a host, being a first user to join the group. The scheduler automatically denotes the host as being responsible for managing a first order for the group. In some embodiments, the host is responsible for organising the contents of the first order. In other embodiments, each user in the group is responsible for submitting their own selections for the first order. In some embodiments, the host is responsible for payment of the entire first order. In other embodiments, each user is responsible for paying for their own selections within an order.

The scheduler utilises the defined ordered sequence to ensure that each user within the group takes a respective turn to manage an order. Once each user within the order has managed an order, responsibility for a successive order returns to the first user in the ordered sequence.

The scheduler provides an interface between the group of related users and the vendor, such that the vendor does not have to deal with manually processing multiple transactions relating to each order from the group of users. In some embodiments, the scheduler is implemented using a remotely located computer server coupled to a communications network, wherein the remotely located computer server is configured to execute software to perform the scheduler functionality, thus rendering an improved computing platform. Each user in the group registers with the scheduler.

In some embodiments, the users utilise a web browser executing on a computing device, such as a smartphone, to register and interact with the scheduler. In other embodiments, the users download a software application (“app”) associated with the scheduler and the app executes on a computing device accessed by the users. For example, the app may be available for download to any computing device, such as a personal computer, mobile computing device, tablet, phablet, and the like and may be available for different operating systems, such as, but not limited to, iOS from Apple, Inc., the Android operating system from the Open Handset Alliance, Windows from Microsoft Corporation, macOS from Apple, Inc., or any other suitable operating system for execution on the user computing device. In some embodiments, a different app is available for users and venues, wherein different functionality is available in the different apps. In other embodiments, a single app is available for users and venues, but different functionality within the app is unlocked during registration, depending on the type of registration.

In some embodiments, the system of the present disclosure incorporates a payment system that effectively splits payments across the group of related users using logic rules and disburses appropriate payment amounts to accounts associated with one or more venues with which the orders have been placed. The payment amounts are optionally based on accumulated transactions made by the group of related users or based on accumulated transactions made by multiple groups of related users.

In some embodiments, the payment system incorporates a holding account into which funds are received from the users and from which funds are paid to accounts associated with venues at which orders are placed by the users. In some implementations, the payment system utilises Stripe, Assembly, or other payment system in order to split payments, transfer to a holding account, and then transfer liabilities to venue accounts to reconcile transactions.

Such a payment system requires a set of logic rules and operating parameters to ensure that payments are received and allocated across multiple orders placed by different users associated with a group.

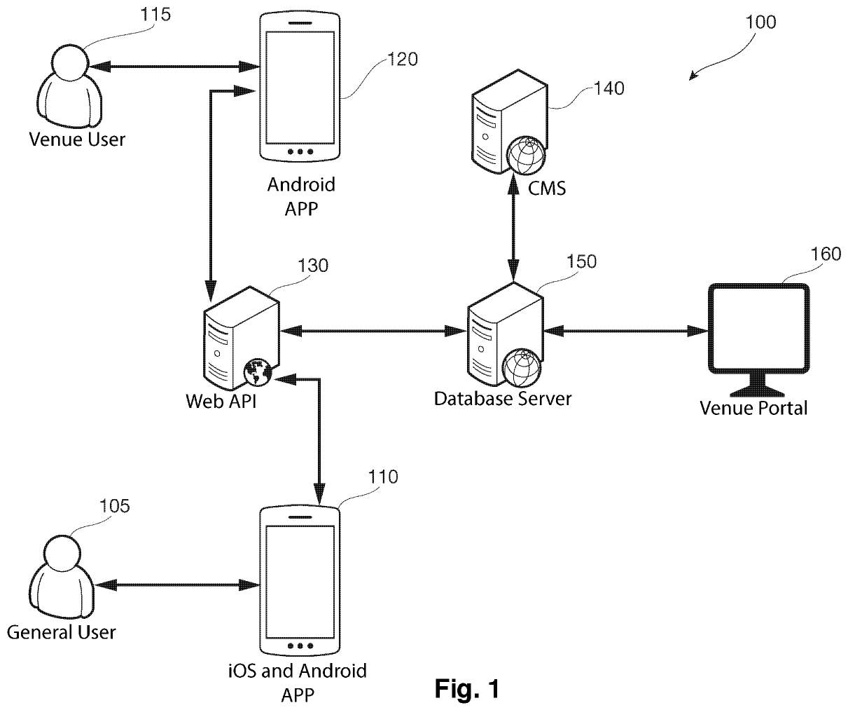

FIG. 1 is a schematic block diagram representation of a multi-instance, multi-user system in accordance with the present disclosure. In the example of FIG. 1, the system may be utilised in the hospitality industry, wherein a group of related users may join each other in a “shout”, with each of the related users taking a turn to purchase a round of drinks or other offerings from a vendor, such as a bar or restaurant. The system provides a technical solution by which to organise automatically multiple orders from groups of related users, whilst distributing payments across the related users in each group.

The system 100 includes a database server 150 on which is executing a scheduler. The system 100 also includes a venue computing device 160, which is coupled to the database server 150 by a communications network. The database server 150 is also coupled to a Content Management Server (CMS) server 140, which stores content for uploading to a website hosted by the database server 150.

In the example of FIG. 1, a vendor associated with the venue computing device 160 registers with the database server 150. Similarly, a user 105 accesses a user computing device 110, such as a personal computer or smartphone, to register with the database server 150 via a Web API 130. As shown in FIG. 1, the user computing device may be implemented using a smartphone executing an app associated with the database server 150. The app may be programmed to operate on the iOS operating system from Apple Inc., the Android operating system from the Open Handset Alliance, or any other suitable operating system for execution on the user computing device 110.

The app downloaded by the user 105 to the user computing device 110 may perform, for example, the following functions:
1. Register
2. Login
3. Edit Profile/Change Password
4. Order drinks
5. Manage group
6. Manage order
7. Payment process→ The payments will be made by the users through a selected payment option, which may include, for example, but is not limited to, PayPal, Stripe, EFTPOS, or electronic wallet. The wallet option will be available in the app and the user will be able to load their wallets with money through their cards.
8. Individual Shout→ such shouts can have one or many people together and host will place the order and each one will pay for themselves for respective orders in each round.
9. Group Shout→ such shouts can have more than one members together and payment could be done in sequence in each round. Host will be paying for the first round and other members pays in sequence one after another in consecutive round. If anyone overrides for next round/s, after override turn over it again follows sequence. For example—suppose there are four members A(host), B, C, & D. after first round C overrides for the next two rounds. In the fourth round of order if no one has overrides yet then B will be paying, for next C will be paying, for further next D will be paying and so on.
10. Even Stevens→ Even Stevens where each member will pay equally where host will place order after confirming each member's order.

The venue computing device 160 may download an app to perform, for example, the following functions:
1. Login
2. PIN login
3. Receive order
4. Complete order

Depending on the implementation, the app downloaded by the venue computing device 160 may optionally be integrated with other EFTPOS or POS software, including inventory management, assigning staff to orders, accounting software, and the like.

The database server 150 stores a user profile associated with the user 105, wherein the user profile contains personal information relating to the user 105. The personal information may include, for example, but is not limited to, name, contact details, and at least one payment method. The payment method may be, for example, selected from one or more of a credit card, PayPal account, escrow account, online bank wallet, or wallet stored by or in association with the database server 150. Alternatively, the payment may be implemented with the assistance of a third-party payment system, such as Stripe, Assembly, or the like. The wallet may be an automatic wallet, in which the wallet is connected to a debit card, credit card, or direct debit function of a bank account, wherein payments are deducted directly from the connected card or account. Alternatively, the wallet may be a manual wallet, whereby the user manually transfers funds to the wallet from a credit card, debit card, or bank account. When the funds in the wallet are exhausted or reach a predefined minimum level, the app sends a notification to the user to top up the wallet.

The system 100 of FIG. 1 provides a transaction architecture that is adapted to manage multiple orders over time from a group of multiple associated users, with various options available for the manner in which charges associated with the respective orders are distributed among those users, payments received from those users, and then funds transferred to the vendor with which the orders are placed.

As an example, the system 100 of FIG. 1 is suitable for use in a hospitality venue, such as a bar, in which a group of associated users, such as a group of friends, participate in a “shout”. In its simplest form, participating in a shout requires that each user in the group takes turn in ordering and paying for a round of drinks. Thus, for a group consisting of users A, B, and C, A buys for A+B+C, the B buys for A+B+C, then C buys for A+B+C. In an alternative scenario, each user participating in a shout pays for their own drinks as they go, but a single order may be placed by the group. That is, A pays for A, B pays for B, and C pays for C, with a single order placed. In practice, there are many different ways in which a shout evolves over subsequent orders, with different users potentially ordering different drinks in different orders and different users assuming responsibility for payment at different times. The system 100 of FIG. 1 provides an architecture that is equipped to address the technical problems of managing the dynamics of multiple orders associated with a group of multiple users.

In one example of a “shout”, a user attends a venue and accesses a software application executing on their computing device to create or join an existing “shout” group. Once all members of the shout group have joined the shout group using the app, each user selects a drink to be ordered from the venue. The app designates, by default, the creator of the shout group as the leader of the next order. The leader receives a group order consisting of the drinks selected by each of the users in the group. The leader confirms the order and clicks a “submit” button on the app, whereby the app sends the order to the venue portal 160 associated with the bar.

On receiving the order, the app allocates costs associated with the order against one or more of the users of the shout group, in accordance with a setting associated with that group shout. When creating the group shout, one default option is for each user in the group shout to be responsible with the cost of a group order when that user is the designated leader of the shout. An alternative option enables the creator of the app to indicate that each user is responsible for the costs associated with each drink selected by that user. A further option distributes the cost of a group order evenly across the users in the group. A yet further option allows the leader to allocate a weighting of costs to each user of the group. Such a weighting may be useful, for example, when a designated driver is consuming cheaper, non-alcoholic drinks and other users are consuming more expensive drinks.

A further option allows a cost associated with a single drink order, such as a single bottle of wine, to be distributed across multiple users within the shout group. For example, users A, B, and C buy a bottle of wine to be shared, in which case the cost of the bottle is split across the three users, with each of users A, B, and C paying for one-third of the cost of the bottle of wine. Various other payment structures may also be available, depending on the implementation, and are managed by a payment system associated with the database server 150.

For example, one implementation includes a VIP option, wherein one or more of the users in a shout group is/are designated as a VIP user. A VIP user may be, for example, a guest of the other users in the shout group, such as a person celebrating a birthday or other special event or occasion. In one arrangement, the app automatically skips over any VIP user as having responsibility for any round of the shout. In one arrangement, the app distributes the costs associated with any VIP users within a shout group over the other users associated with the shout group, such that any such VIP users do not have to pay for any of their drinks ordered throughout the shout.

In some embodiments, the database server 150 incorporates a payment system that receives payments from registered users and stores those payments in a holding account. Thus, the payment system is configured to track and manage liabilities incurred by each user and under which payment method. A user may have multiple payment methods from which to select and may select different payment method for each round within a shout or across different shouts.

The payment system manages payments from the holding account to accounts associated with the vendor(s) associated with the venue portal 160. In one arrangement, multiple hospitality venues belong to a single trading entity and the payment system arranges transfer of funds to a single account associated with the trading entity, wherein the transfer of funds corresponds to shouts ordered and delivered across the multiple hospitality venues. In some embodiments, the payments to the hospitality venues are made in near real-time as each order is processed. In other embodiments, the payments to the hospitality venues are aggregated and paid at the end of a predefined time period, such as the end of each day. The number of transactions to be tracked and managed may be in the hundreds or even thousands per day, across hundreds or thousands of users at hundreds or thousands of venues. Managing the large number of users, payment methods, and liabilities for each order across the many venues is a significant technical challenge.

Depending on the implementation, the payment system may also determine any commissions payable to the operator of the database server 150 and arrange for the commissions to be paid from funds received from the users.

Once the order has been filled by the venue and is ready for collection, the venue portal 160 sends a notification to the database server 150, which in turn sends a notification to the app such that the leader of the shout knows that the order is ready for collection or will be delivered shortly, depending on the level of service offered by the venue.

The system 100 also shows a venue user 115 who utilises a computing device 120 to communicate with the database server 150 via the Web API 130.

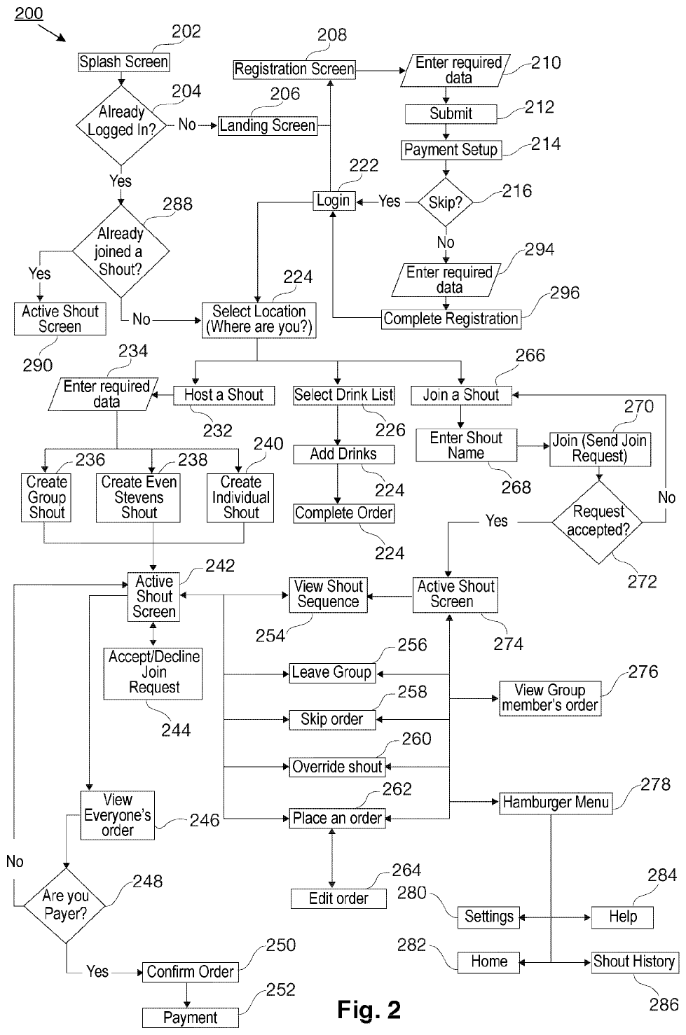

FIG. 2 is a flow diagram illustrating a method 200 of implementing a multi-instance, multi-user service system utilising the system 100 of FIG. 1. The method 200 begins at step 202, in which the user 105 accesses the user computing 110 coupled to a communications network and receives a splash screen associated with the database server 250. In this example, the content displayed on the user computing device 110 is presented by an app executing on the user computing device 110, wherein the app is associated with the database server 250. In alternative embodiments, the content displayed on the user computing device 110 may be serviced by a web application (web app) hosted on the database server 250 or a website hosted on the database server 250.

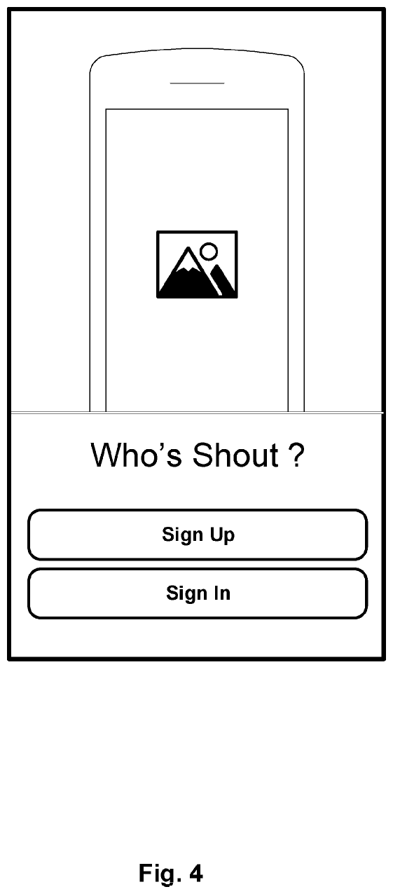

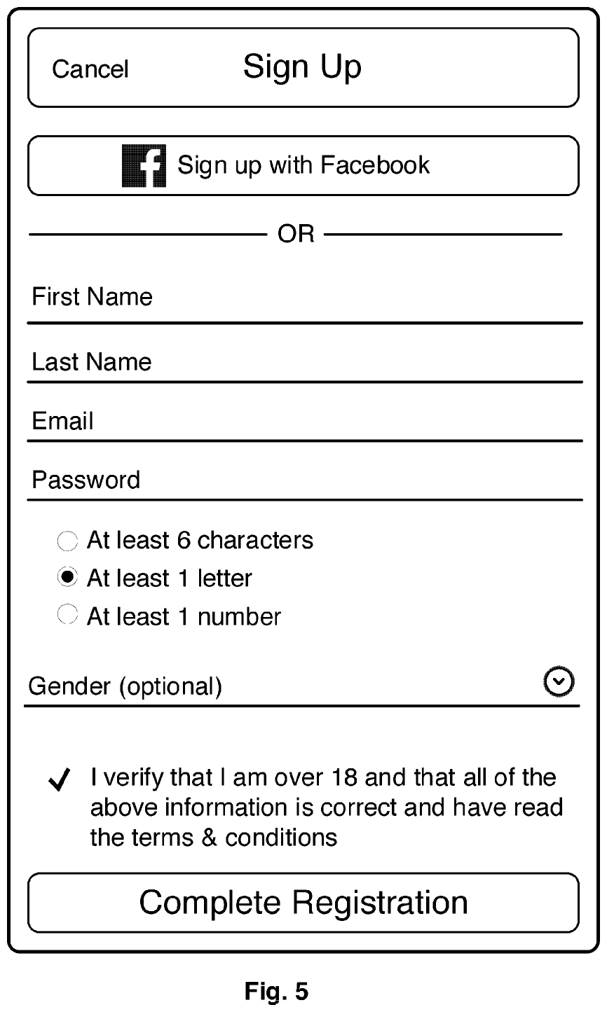

Control moves from step 202 to decision step 204, which determines whether the user 105 is already logged in. If the user has not logged in or is a new user, No, control passes to step 206, which is a landing screen, as exemplified in FIG. 4. The landing screen provides the user 105 with the option of registering or logging in. If the user 105 is a new user, control passes to a registration screen at step 208. An example of a registration screen is shown in FIG. 5. In a subsequent step 210, the user 105 enters a set of required data. Depending on the implementation, the required data may include, for example, but is not limited to, name, age, and contact details. In the example of FIG. 5, the user is required to enter a password having at least 6 characters, including at least 1 letter and 1 number. Alternatively, the user is able to register by using credentials from an existing account associated with a social networking system, such as a Facebook account, or the like. Control passes from step 210 to step 212, in which the user 105 submits the data entered in step 210 into the app.

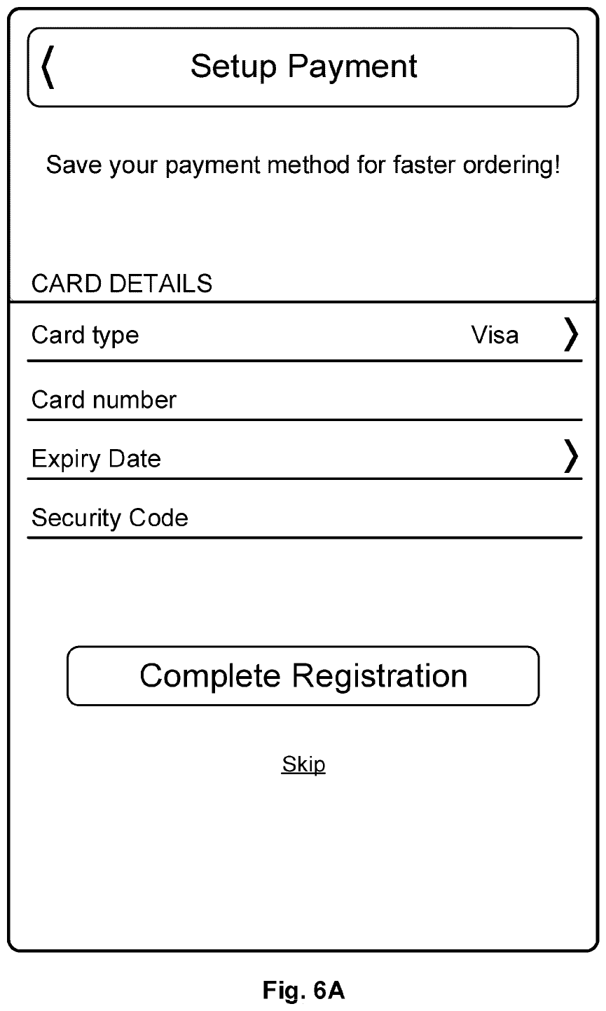

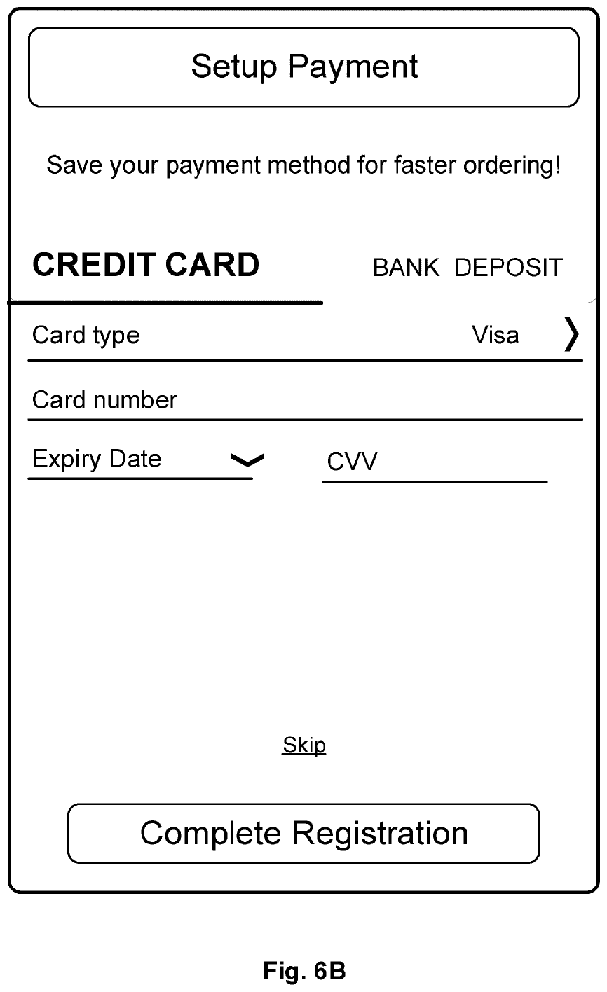

At step 214, the user 105 sets up at least one payment method. Depending on the implementation, the app may offer the user 105 one or more payment options. In one implementation, the app offers the user 105 a single payment option, such as a credit card, as shown in FIG. 6A. In an alternative implementation, the app offers the user 105 a set of payment options that may be populated. Such payment options may include, for example, but are not limited to, a credit card, PayPal account, debit account, online bank wallet, or wallet stored by or in association with the database server 150. FIG. 6B shows an embodiment in which the user is able to select a payment option from a credit card or direct bank deposit. The user 105 selects one or more payment options and enters the required details. Where the user 105 enters more than one payment option, the app asks the user 105 to select a default payment option. Alternatively, the app automatically selects a first entered payment option as the default payment option. Having multiple payment options enables the user 105 to enter multiple payment options for different purposes. For example, the user 105 may enter multiple payment options relating to multiple credit cards, with a first credit card to be used for personal expenditure and a second credit card to be used for work-related expenditure.

Control passes from step 214 to a decision step 216, which is a Skip step that allows the user 105 to skip some details for the complete registration. If the user 105 decides to Skip, Yes, control passes to step 222, in which the user 105 logs into the service system administered by the database server 150. The login screen may take many forms, but may be implemented using a username and password combination, biometric information, and the like.

Returning to step 216, if the user 105 does not Skip, No, control passes to step 294 in which the user 105 enters required data and then completes the registration in step 206, before control passes to step 22 for the user 105 to log in to the service system administered by the database server 150.

Once the user 105 has logged in at step 222, control passes to step 224, in which the user 105 selects a location corresponding to a venue that the user 105 is attending and which has also registered with the service system. In one arrangement, the app provides the user 105 with a search bar into which the user 105 can enter the name of the venue. In another arrangement, the app provides a map or list of venues, based on a geolocation device associated with the user computing device 110 to provide the user 105 with a list of venues within the immediate proximity of the user 105. Optionally, each venue is associated with an image to assist the user 105 in identifying the correct venue. Depending on the implementation, the image or text associated with a venue may allow the respective venue to advertise promotions, special events, or directions and/or conditions to access the venue. Optionally, the list of venues is sorted based on proximity to the user 105. Further optionally, the app provides one or more icons associated with the services offered at each venue. In another arrangement, the app provides a combination of the above features to facilitate the user 105 identifying and entering the venue, or area within the venue, that the user 105 is attending. In larger establishments, the selected venue may be a particular bar or region of the establishment, such that the establishment may be represented by multiple bars or regions in the app. Within a selected venue, the app optionally provides a set of bars or ordering points associated with that venue. For example, at a large stadium venue, the app may present one or more bars or restaurants within a particular stand or seating region.

Some venues offer table service, wherein completed orders are delivered to the ordering user. In such venues, the app provides an input dialog box into which the user 105 may provide an appropriate table number, seat number, private lounge, or private room to which completed orders are to be delivered.

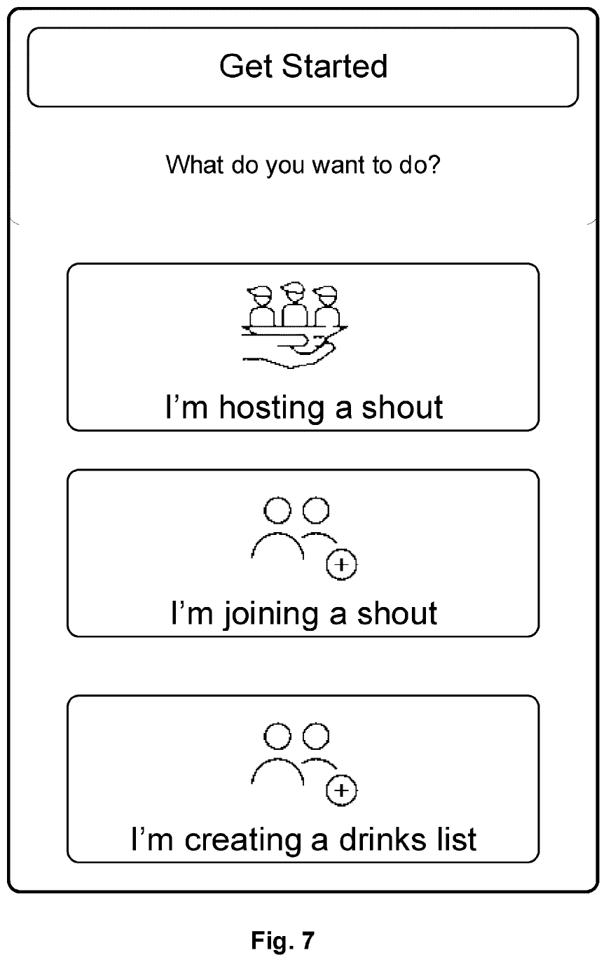

The service system is adapted to enable a group of related users to make multiple orders. In the example of FIG. 2, the service system is implemented in the hospitality industry, wherein a group of related users may join each other in a “shout”, with each of the related users taking a turn to purchase a round of drinks or other offerings from a vendor, such as a bar or restaurant. Having selected a venue, the system displays, in one embodiment, a “Get Started” screen, as shown in FIG. 7, which allows the user to host a shout, join a shout, or create a drinks list.

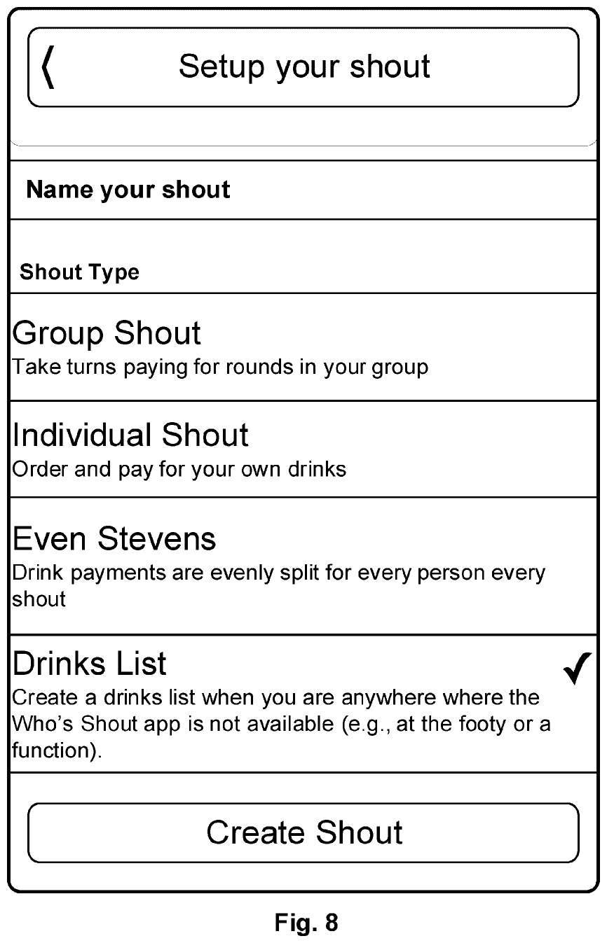

In the method 200 of FIG. 2, there are four different options available to the user 105, as illustrated in FIG. 8:
Create a Group Shout (step 236);
Create an “Even Stevens” shout” (step 238);
Create an Individual Shout (step 240); or
Create a Drinks List (step 226).

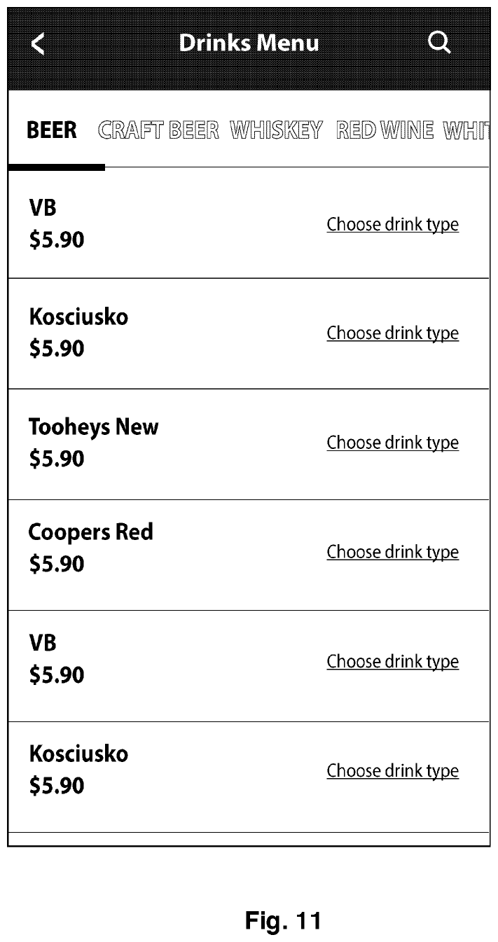

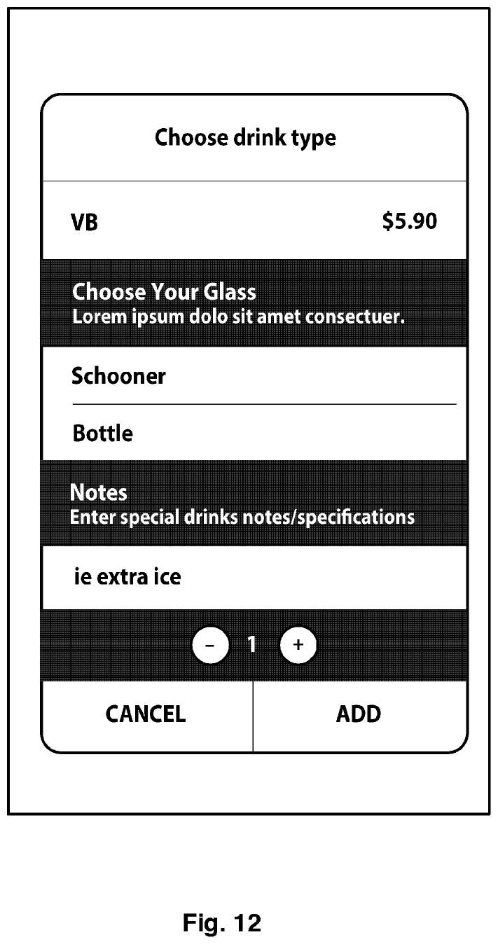

In a simple example, the user 105 attends a venue by herself or is paying for all drinks relating to a single order. Control passes from step 224 to step 226, in which the user 105 selects a drink list provided as a result of the user 105 selecting a venue in step 224. In step 228, the user 105 adds one or more drinks to the order using an input presented on the user computing device 110. FIG. 11 is an example of a screen presented to the user computing device 110 to enable each user to select a drink or drinks for a shout. It will be appreciated that many different formats may be utilised to enable the user 105 to select a drink or food to order. While FIG. 11 shows a tab arrangement, with different types of drinks accessible by selecting different tabs, a combination of tabs, dialog boxes, check boxes, drop down menus, and the like, may equally be practised. Having selected a particular drink, the app optionally displays a menu for the user 105 to select options associated with the drink, such as size, straw, ice, and the like, as shown in FIG. 12. In the example of FIG. 12, the user 105 has selected VB as the type of drink, being a type of beer, and then selected a schooner, which is a standardised drink size of 425 mL.

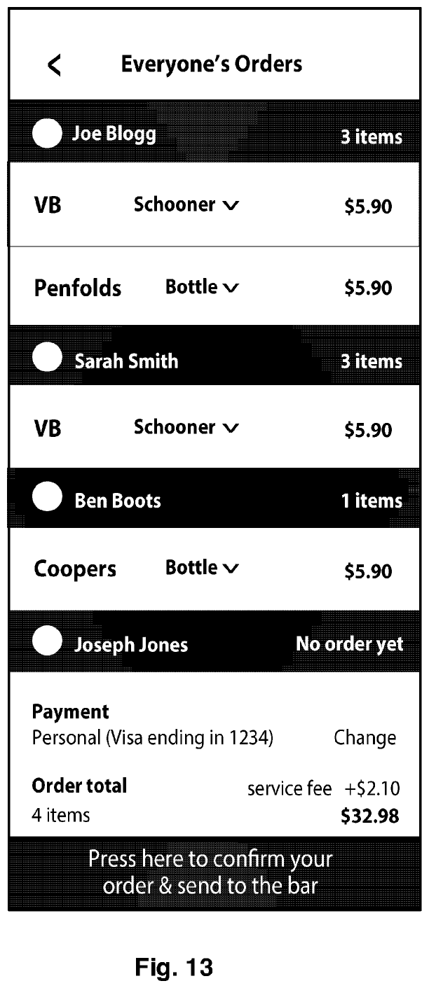

Control passes to step 230, in which the user 105 submits the order. As part of the order submission, the app optionally displays a summary of the order, including cost and any administration fees or tip, for the ordering user to verify. An example of such a summary screen is shown in FIG. 13. The user 105 is able to review the drinks to be ordered and confirm the price before submitting the order. The summary screen lists all the orders from every member of the shout group. Optionally, the host or viewing user's order is displayed at the top of the list of orders. For each order, the summary screen it displays a number of items, along with their respective price by particular member separated in separate section. The summary screen of FIG. 13 shows a payment region that indicates the payment method that has been allocated by the scheduler, based on which user is responsible for the current round and the payment method associated with that user. In the example of FIG. 13, a personal credit card ending in “1234” is to be charged for the round. The user is able to change the payment method to another payment method associated with that user, such as an alternative credit card, payment wallet, or payment gateway. If the user has multiple payment methods associated with that user, the user is able to select from among those payment methods. In one implementation, the user 105 selects a default payment option to be stored in a user profile, when registering with the system. The user 105 is able to select a payment option for each order, overriding any default payment option that might be stored.

The order is forwarded by the app executing on the user computing device 110 to the venue computing device 160, via the database server 150. After the order has been confirmed and the confirmation button has been clicked, the payment method of the host of the current round of the shout will be checked to see if they have sufficient balance or not to pay for the orders. If the balance is found insufficient or the credit card is denied, then the host will be notified to load their wallet, check the balance of the nominated credit card, or change to an alternative payment method so that the transaction can proceed.

In one arrangement in which the user is utilising a payment wallet and the balance is found insufficient when placing an order, then the system displays a pop-up message that provides two options: Automatically and Manually to load the wallet. If the Automatically option is clicked then, the remaining required amount for the order will be loaded automatically in the wallet from the default set card. If the Manually option is clicked, then the user will be directed to the Wallet screen where the user will have to load balance in the wallet manually.

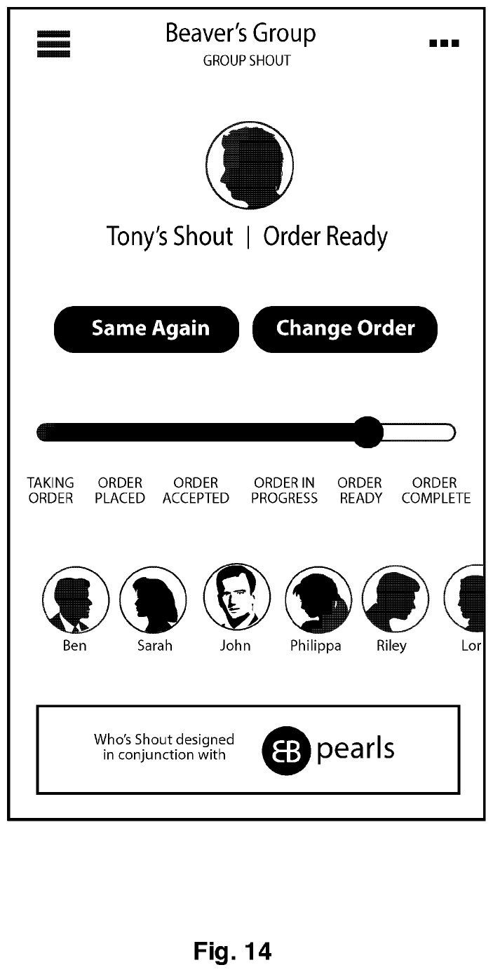

The venue computing device 160 receives the order and the order is processed to be filled by an employee at the venue. In one implementation, the venue computing device 160 sends a notification to the user 105 once the order has been filled and is ready for collection. For example, in one implementation, the notification is an in-app notification or Short Message Service (SMS) text message informing the user 105 that the order has been filled and is ready for collection at a nominated place in the venue, such as that displayed in FIG. 14. In an alternative implementation, the user 105 indicates a table number when placing the order, in which case an employee of the venue is able to deliver the order to the user 105 at the nominated table number.

Depending on the implementation, the database server 150 optionally stores details about the order in the user profile associated with the user 105. Storing order details enables the database server 150 to customise information presented to the user 105 on a display of the user computing device 110 when using the app. For example, the app can be configured to display favourite drinks preferred by the user 105, based on previous drink orders, when those drinks are offered by a current venue being attended by the user 105. The database server 150 is optionally configured to present recommendations to the user 105 based on previous orders, such as to promote current specials, new offerings from the current venue, or proposed substitutes if the usual drink ordered by the user 105 is not available.

Let us consider an alternative scenario, in which the user 105 wishes to begin a shout for a group of related users. Returning to step 224, control passes to step 232, in which the user 105 inputs to the user computing device 110 that the user 105 wishes to host a shout. Control passes to step 234, in which the user 105 enters a set of required data, which may include a name for the shout. The system only allows unique names for the shouts, so that different shouts hosted associated with different groups of people are not confused. Depending on the implementation, the user 105 optionally invites one or more persons from a contacts list associated with the user 105 and stored on the database server 150.

If the user 105 selects a “Group Shout”, the scheduler creates an ordered sequence listing consisting of the set of users that join the group shout. The ordered sequence listing is arranged corresponding to the order in which each user joins the group shout. A group shout is an arrangement by which a set of users join the group shout and then take turns to pay for each round of the shout. For an initial order (or “round”), the host will pay for the drinks. For a next subsequent order, the scheduler selects the first user whose request to join this shout gets accepted by the particular host as being responsible for that next subsequent order. As each group associated with a shout is joined by subsequent users, the scheduler maintains an order list of related users in that shout and automatically assigns payment to users based on their order in the list corresponding to the number of the order placed by that shout group. For subsequent orders, the scheduler manages the group of related users involved in the shout, such that each user in the group takes turn in paying for rounds. The scheduler stores details about the group shout, including the ordered sequence and which user is responsible for the next shout.

If the user 105 selects “Individual Shout”, then the scheduler allocates the user 105 as being responsible for the order. If the user 105 selects “Even Stevens”, then the scheduler allocates an equal payment to each of the multiple users associated with a shout, for each round of the shout. That is, the payments are allocated automatically to be evenly distributed across all members of a shout group.

To create a group shout, control passes from step 234 to step 236, in which the user 105 creates a group shout. When a group shout is created, the scheduler creates an ordered sequence, with each user that joins the group shout being added, in turn, to the ordered sequence. The ordered sequence defines which user is “the host” responsible for each round of a shout. The scheduler moves through the ordered sequence each time a round of a shout is completed by assigning the next user in the ordered sequence as the host for the next successive round of the shout. The scheduler also stores each group shout that is created and tracks which user in a shout group is responsible for a current round of the shout. By storing the group shout, the ordered sequence associated with the group shout, and a current user responsible for a current round, the users in that group shout are able to continue that group shout, in the correct order, at any later time.

Control then passes from step 236 to an active shout screen 242. In one implementation, the active shout screen 242 displays to the user 105 a set of available options. In this example, the options include: create a Group Shout, create an Individual Shout, create an Even Stevens Shout, or create a Drinks List, At step 236, if the user 105 wants to create an Even Stevens shout, control passes to step 238 to create the Even Stevens shout and then on to step 242. Alternatively, if at step 236 the user 105 wants to create an individual shout, control passes from step 236 to step 240 to create the individual shout and then control passes to step 242. In some circumstances, it may be useful for the user 105 to create a Drinks List. For example, a venue might not yet support the ordering system of the present disclosure, yet the user 105 is able to create a drinks list for a group shout, such that the user 105 is able to receive orders from all users within the shout group and does not have to remember the individual orders when placing an order manually for the group shout.

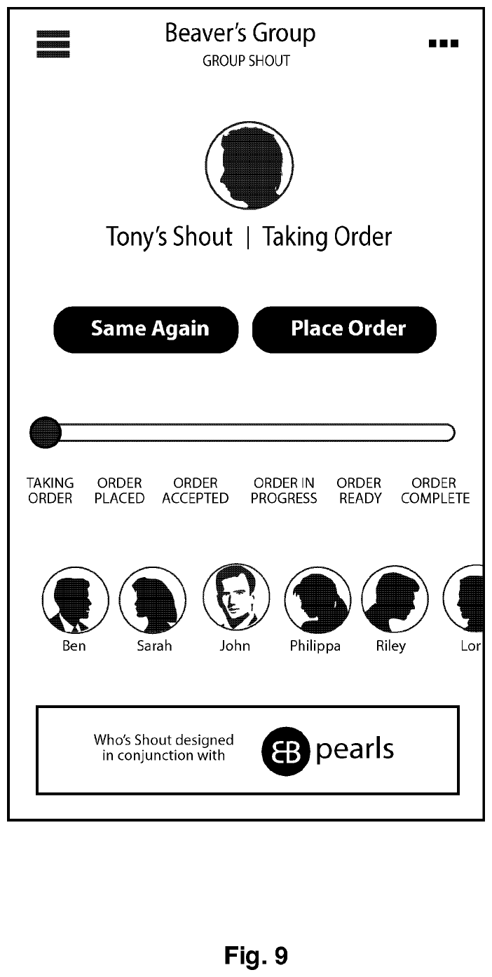

At step 242, the user 105 is presented with an active shout screen, such as that shown in FIG. 9. In the example of FIG. 9, the active shout screen indicates that the group shout is called “Beaver's Group”, it is Tony's shout, and the shout is at the stage of taking orders from other users participating in the shout. This is indicated both in text and in a timeline on the display. The name of the user responsible for a shout will change from shout to shout, as governed by the scheduler. In order to expedite orders, the user responsible for the shout can activate a “Same Again” button, which simply places a new order corresponding to the most recent order placed by that group. For the first round of a shout, the “Same Again” button is disabled, by default. Optionally, the scheduler may store a history of orders placed by the same group and display the most recent order from that group as a suggestion for the initial order. Further optionally, the scheduler may display as a suggestion the most recent order from the same group corresponding to the present venue.

The timeline displayed in FIG. 9 shows the stages of the order:
a. Taking order: reflecting that s/he is going to initiate the ordering process.
b. Order Placed:- order has been sent to the bar to be processed.
c. Order accepted:- bar has accepted the order.
d. Order in progress:- bar is preparing the order.
e. Order Ready:- Order is ready for pickup (notify shouter if they are not in app).
f. Order Completed:- Order has been collected by the shouter and the bar has marked order as completed.

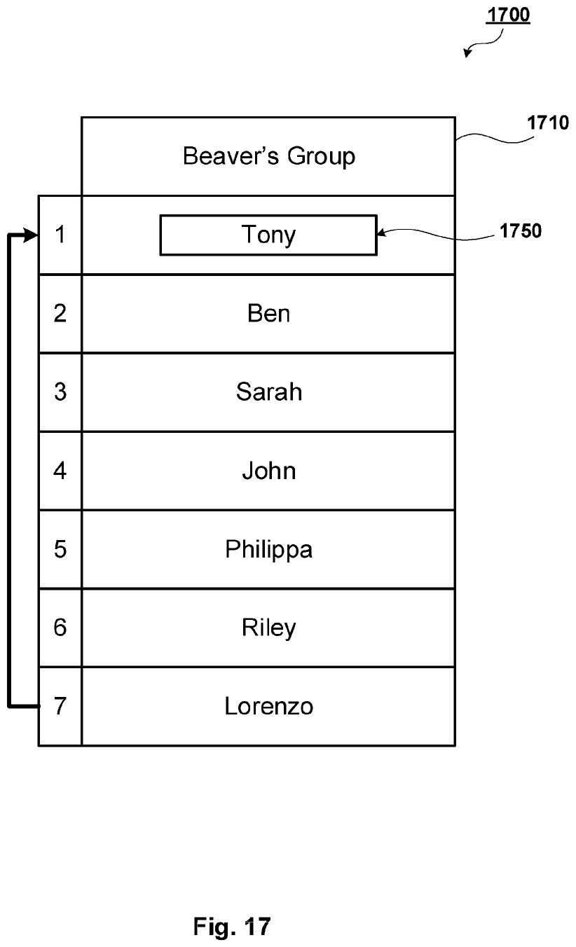

FIG. 17 is a schematic block diagram representation of a circular linked list 1700 stored by the scheduler in relation to the Beaver's Group shout of FIG. 9. The circular linked list 1700 is called “Beaver's Group” and has 7 participants: Tony, Ben, Sarah, John Philippa, Riley, and Lorenzo. Each of the participants in the Beaver's Group shout is listed in the order in which they respectively joined that group shout. The scheduler maintains a pointer 1750 that indicates the participant that is responsible for the current round. In this example, the pointer 1750 indicates that it is Tony's shout. The pointer 1750 cycles through the circular linked list as each shout is completed. Once Lorenzo has completed his shout, the pointer 1750 returns to Tony at the beginning of the circular linked list. When any of the participants leaves, the scheduler removes that participant from the linked list. In one implementation, when the creator of the group shout leaves, then the shout terminates and a new shout group must be created by the remaining participants, if they choose to do so. In another implementation, when the creator of the group shout leaves, the shout continues with the creator being deleted from the linked list of participants for the shout. It will be appreciated that other data structures capable of tracking an ordered sequence may equally be practised.

For each participant in the group shout, the scheduler stores information relating to what was ordered for each round. This enables the participant to view the number and type of drinks consumed and readily re-order drinks for a new shout. Further, the scheduler stores the composition and order of each group shout, such that the members of each group shout can stop a shout at any time and then recommence that shout, with the same members, at a later time, which may be later that day or many days or months later.

In step 246, the user 105 is able to view the orders submitted by other users in the shout. Control passes to step 248, which determines whether the user 105 is the payer for the current round of the shout. If the user 105 is the payer, Yes, control passes to step 250, in which the user 105 confirms the order. Control passes to step 252, in which payment is made for the order by the database server 150 transferring the appropriate funds to the current venue, based on a payment method stored in relation to the user profile associated with the user 105. If at step 248 the user 105 is not the payer for the current round, control returns to step 242.

Returning to step 242, the user 105 is able to perform a number of functions. The user 105 is able to view a shout sequence 254, leave the group 256, skip an order 258, override a shout 260, or place an order 262. If the user 105 chooses to place an order, the user 105 also has the option of editing an order 264.

In relation to step 260, any user within a set of related users associated with a shout is able to override a sequence of users based on the order in which the users joined the particular shout. For example, a user may choose to override the current order and does so by selecting an override option within the app. Depending on the implementation, the override button only works for the next single shout or alternatively may allow the overriding user to select a number of shouts for which to be responsible.

The above scenarios related to the user 105 hosting a shout or already in a shout. In an alternative scenario, the user 105 joins an existing shout hosted by another user. From step 224, control passes to step 266, in which the user 105 elects to join an existing shout. In one implementation, the user 105 needs to know and enter the name of the existing shout, in order to lodge a request to join that shout. In another implementation, the system displays any shouts that are currently active and which involve a user registered with the system and associated with the user 105. The association may be, for example, that the user and user 105 have previously been in a shout together, or that they are linked through a social networking system, or that they are linked within the system. In a further implementation, the app displays all active shouts for the venue being attended by the user 105.

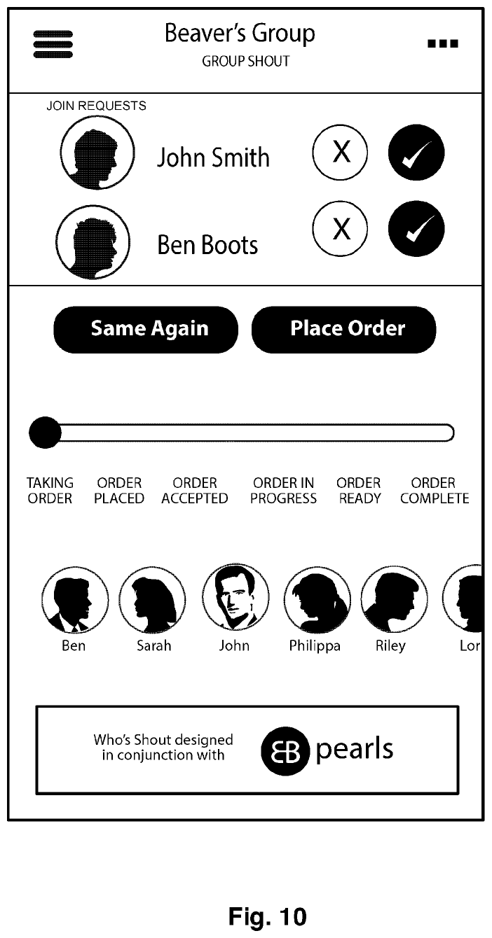

At step 268, the user 105 enters a selected shout name and then at step 270 indicates that the user 105 wants to join that selected shout, at which point the user computing device 110 sends a request to the database server 150. Decision step 272 determines whether the request to join the selected shout is accepted. Depending on the implementation, only the initiating host of the shout is able to accept or reject requests by new members to join the group. Alternatively, any member of an existing shout is able to accept or reject a request by a new member to join the group. If the request is accepted, Yes, control passes to an active shout screen 274. FIG. 10 shows an example of an active shout screen, indicating that the group is named “Beaver's Shout” and users John Smith and Ben Boots have applied to join that shout. In the example of FIG. 10, the host is able to accept or reject a request to join the group by clicking on a “X” to reject the request or “✓” to accept the request. If the request to join a shout is rejected, No, then control returns from step 272 to step 266.

From step 274, the user 105 as a participant in a shout can view a shout sequence 254, leave the group 256, skip an order 258, override a shout 260, place an order 262, or view a group member's order 276. In the example of FIG. 2, the user 105 is also able to view a hamburger/food menu 278, from which the user 105 can access setting 280, help 284, a home screen 282, or view shout history 286.

Returning to step 204, if the user 105 is already logged in, Yes, control passes to decision step 228, which determines whether the user 105 is already part of a shout. If the user 105 is already part of a shout, Yes, control passes to step 290, which displays an active shout screen on the user computing device 110. If at step 288 the user 105 has not already joined a shout, No, then control passes to step 224 for the user 105 to select a current venue and then follow the steps described above to either commence a shout or join an existing shout.

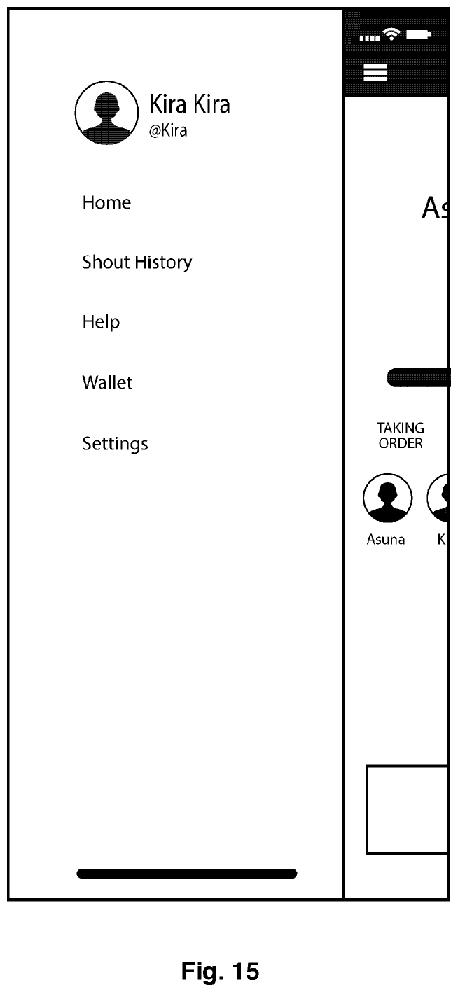

FIG. 15 is a screenshot of a user profile screen available for viewing by a user Kira Kira. In the example of FIG. 15, the user is able to view a Shout History, which enables the user to view past shout orders. Depending on the implementation, the Shout History may be restricted to a current venue and day. Alternatively, the Shout History is sorted based on date. Alternatively, the user is able to select one or more filters by which to sort the Shout History, such as venue, date, shout participants, cost, payment method, and the like. The user profile screen also enables the user to access help, settings, and payment wallet settings.

Each venue registered with the system can access a dashboard that provides information relating to orders placed through the system. Various layouts may be implemented to show a venue staff member information relating to present and past orders. In one arrangement, each order includes a status, indicating the status of that order. The status may include, for example, the time at which the order was received, the staff member fulfilling the order, the name of the bar at which the order was placed, an order number, and the like. Depending on the implementation, the status of orders may be colour coded to reflect whether the order is pending, completed, or whether the time taken to complete the order is beyond a predefined time limit. The venue portal also provides a platform by which the venue is able to view the number and types of products (e.g., drinks, food, etc.) ordered, the time at which certain products are ordered, the efficiency of staff, etc. This information can be very useful for managing inventory levels and staffing, particularly in venues that may have multiple bars, bistros, or other serving points.

On completion by the venue of an order, the system optionally includes a notification function whereby the venue staff press a button on the dashboard associated with the order. On pressing the button, the system sends a notification to the host of the shout, such as by one or more of an in-app message, a Short Message Service (SMS) text message, email, or the like.

In one arrangement, the system causes the app executing on a computing device accessed by the host to place the order to issue a notification by changing a portion of a display screen of that computing device to a defined colour. For example, when the host utilises a smartphone, a portion of the display screen of the smartphone, including the entire display, may change to green to indicate that the order is ready for collection. Depending on the implementation, the screen may flash to give greater notification to the host that the order is ready for collection.

The notification may be associated with an audible notification, such as a tone, music, or the like. Further, the notification may be associated with, or be comprised solely of, haptic feedback, such as causing the computing device to vibrate. Some computing devices are equipped with, or may be enhanced with, projectors. In such computing devices, the notification may include projecting an image from the computing device to alert the user that the status of the order has changed, wherein the projected image may be accompanied by audio. The projected image may be a static image or dynamic video. In a different implementation, all users of a group shout receive a notification that an order has been completed and is ready for collection. Any and all combinations of colour, sound, projections, and haptic feedback may be utilised to alert the host that an order is ready for collection.

Some embodiments include optional functionality wherein an app executing on a user computing device includes a button that enables the user to access a third-party service provider. In this way, the user is able to access, for example, an account associated with the third-party service provider from within the host application.

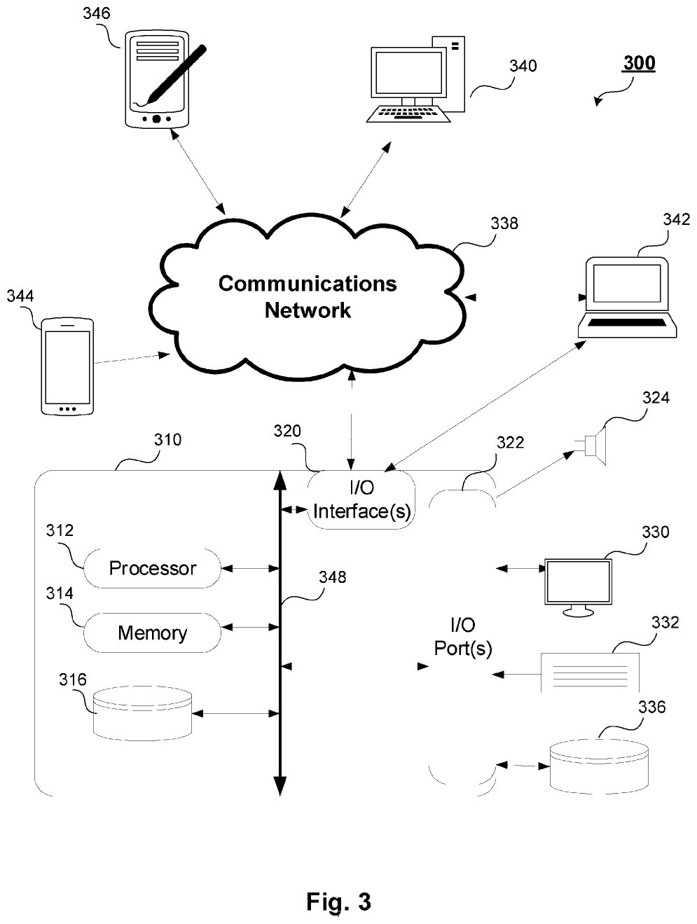

The system of the present disclosure for managing multiple orders associated with a group of multiple people may be practised using one or more computing devices, such as a general purpose computer or computer server, such that when implemented in accordance with the present disclosure gives rise to an improved computing system. FIG. 3 is a schematic block diagram representation of a system 300 that includes a general purpose computer 310. The general purpose computer 310 includes a plurality of components, including: a processor 312, a memory 314, a storage medium 316, input/output (I/O) interfaces 320, and input/output (I/O) ports 322. Components of the general purpose computer 310 generally communicate with each other using one or more buses 348.

The processor 312 be implemented using any device or portion of a device that processes electronic data (e.g., from registers and/or memory to transform that electronic data into other electronic data that may be stored in registers and/or memory). The processor 312 may be representative of one or more processors operating individually, sequentially, or in parallel. The processor 312 may execute code to perform as a scheduler for creating, storing, and managing data relating to multiple users, shout groups, and orders associated with those users and shout groups.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to implement a mode of operation in accordance with the executed instructions. The memory 314 may also be utilised to store each group shout as a circular linked list with a pointer identifying a user responsible for a current shout. The memory 314 may also store historical data pertaining to previously created shout groups, orders, and the like.

One or more peripheral devices may be coupled to the general purpose computer 310 via the I/O ports 322. In the example of FIG. 3, the general purpose computer 310 is coupled to each of a speaker 324, a display device 330, an input device 332, and an external storage medium 336. The speaker 324 may be implemented using one or more speakers, internal to the computing device 310 or external to the computing device 310, such as in a stereo or surround sound system. In the example in which the general purpose computer 310 is utilised to implement a user computing device 110 or venue computing device 160, the peripheral devices may include a speaker to alert a user of notifications or the like.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, solid state drive (SSD), or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be implemented using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a server acting as the data server 150 and/or the venue portal 160 shown in FIG. 1 and described in relation thereto. In such an embodiment, the memory 314 and storage 316 are utilised to store data relating to registered users and registered venues. Software for implementing the data management and transmission system is stored in one or both of the memory 314 and storage 316 for execution on the processor 312. The software includes computer program code for implementing method steps in accordance with the method for passively acquiring data described herein.

Embodiments of the present disclosure are not limited to any particular implementation or programming technique and the invention may be implemented using any appropriate techniques for implementing the functionality described herein. Furthermore, embodiments are not limited to any particular programming language or operating system.

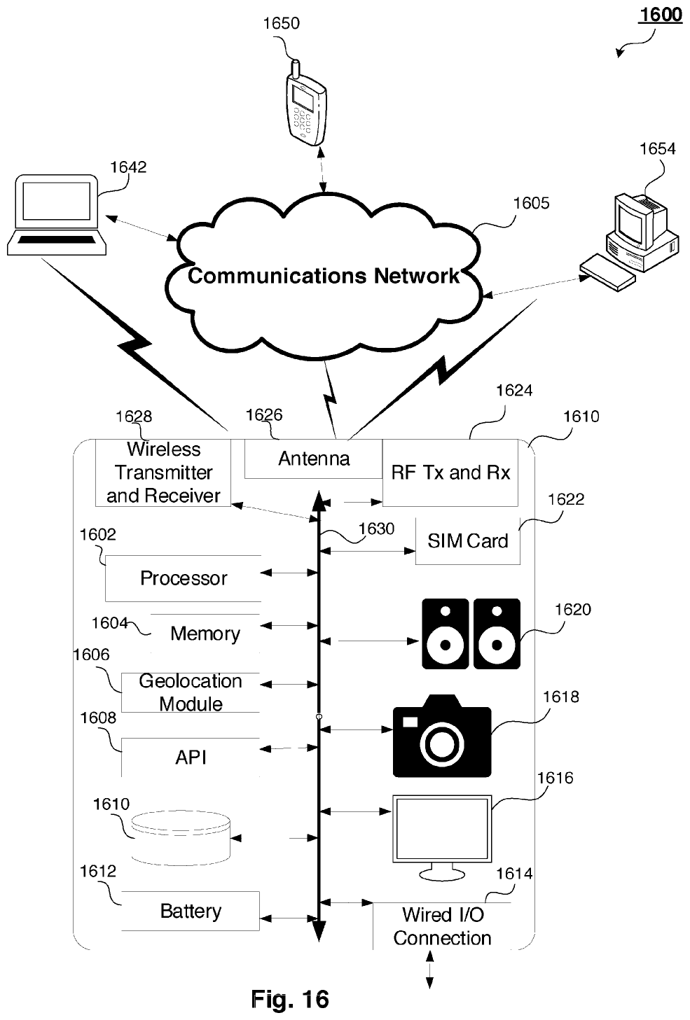

FIG. 16 is a schematic block diagram representation of a system 1600 on which one or more aspects of an multi-order, multi-user method and system of the present disclosure may be practised. The system 1600 includes a portable computing device in the form of a smartphone 1610, which may be used by the registered user 105 of the multi-order, multi-user ordering system implemented using the database server 150 of FIG. 1.

The smartphone 1610 of FIG. 16 includes a plurality of components, including: a processor 1602, a memory 1604, a geolocation module 1606, an Application Programming Interface (API) module 1608, a storage medium 1610, a battery 1612, a wired input/output (I/O) connection 1614, a display screen 1616 (such as a capacitive touchscreen), one or more cameras 1618, one or more speakers 1620, a subscriber identity module (SIM) card 1622, a radio frequency (RF) transmitter and receiver 1624, an antenna 1626, and a wireless transmitter and receiver 1628 (such as a Wi-Fi and/or Bluetooth transmitter and receiver). Components of the smartphone 1610 generally communicate using one or more bus connections 1630 or other connections therebetween.

The wired I/O connection 1614 is adapted to couple the smartphone 1610 to a power outlet or charging device to recharge the battery 1612 or to couple the smartphone to a computing device, such as the general purpose computer 310 of FIG. 3. The wired I/O connection 1614 may include one or more connectors and may be adapted to enable uploading and downloading of content from and to the memory 1604, storage medium 1610 and SIM card 1622.

The memory 1604 may include Random Access Memory (RAM), Read Only Memory (ROM), or a combination thereof. The storage medium 1610 may be implemented as one or more of a solid state “flash” drive, a removable storage medium, such as a Secure Digital (SD) or microSD card, or other storage means. The storage medium 1610 may be utilised to store one or more computer programs, including an operating system, software applications, and data. In one mode of operation, instructions from one or more computer programs stored in the storage medium 1610 are loaded into the memory 1604 via the bus 1630. Instructions loaded into the memory 1604 are then made available via the bus 1630 or other means for execution by the processor 1602 to implement a mode of operation in accordance with the executed instructions.

The geolocation module 1606 may be used to determine a geographical position of the smartphone 1610, such as based on Global Positioning System (GPS) satellites, cellular telephone tower triangulation, or a combination thereof. The determined geographical position may then be made available to one or more programs or applications running on the processor 1602 for use within those programs or applications or to be shared to external computing devices and systems.

The wireless transmitter and receiver 1628 may be utilised to communicate wirelessly with external peripheral devices via Wi-Fi, Bluetooth, infrared, or other wireless protocol. In the example of FIG. 16, the smartphone 1610 is coupled wirelessly to a personal computer 1642.

The wireless transmitter and receiver 1628 and/or the RF transmitter and receiver 1624, in conjunction with the antenna 1626, are adapted to couple the smartphone 1610 to available communications networks 1605. The communications network 1605 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

In one implementation, the SIM card in conjunction with the RF transmitter and receiver 1624 enable the smartphone 1610 to couple to a cellular communications network and then, in turn, to the Internet. Alternatively, or additionally, the smartphone 1610 utilises the wireless transmitter and receiver 1628 to couple the smartphone to a local wireless network that is, in turn, coupled to a communications network, such as the Internet. In this way, the smartphone 1610 is able to communicate with other computing devices coupled to the communications network 1605, such as the second smartphone 1650, the personal computer 1642, and the personal computer 1654.

In one example, the display device 1616 is implemented using a liquid crystal display (LCD) screen. The display 1616 is used to display content to a user of the smartphone 1610. The display 1616 may optionally be implemented using a touch screen, such as a capacitive touch screen or resistive touchscreen, to enable a user to provide input to the smartphone 1610.

The SIM card 1622 is utilised to store an International Mobile Subscriber Identity (IMSI) and a related key used to identify and authenticate the user on a cellular network to which the user has subscribed. The SIM card 1622 is generally a removable card that can be used interchangeably on different smartphone or cellular telephone devices. The SIM card 1622 can be used to store contacts associated with the user, including names and telephone numbers. The SIM card 1622 can also provide storage for pictures and videos. Alternatively, contacts can be stored on the memory 1604 or the storage medium 1610.

The system disclosed herein provides an improved computer system for managing and scheduling multiple orders from multiple users.

### INDUSTRIAL APPLICABILITY

The arrangements described are applicable to the hospitality and service industries.

The foregoing describes only some embodiments of the present invention, and modifications and/or changes can be made thereto without departing from the scope and spirit of the invention, the embodiments being illustrative and not restrictive.

Reference throughout this specification to “one embodiment,” “an embodiment,” “some embodiments,” or “embodiments” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

While some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practised without these specific details. In other instances, well-known methods, structures and techniques have not been shown in detail in order not to obscure an understanding of this description.

Note that when a method is described that includes several elements, e.g., several steps, no ordering of such elements, e.g., of such steps is implied, unless specifically stated.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

Similarly, it is to be noticed that the term coupled should not be interpreted as being limitative to direct connections only. The terms “coupled” and “connected,” along with their derivatives, may be used. It should be understood that these terms are not intended as synonyms for each other, but may be. Thus, the scope of the expression “a device A coupled to a device B” should not be limited to devices or systems wherein an input or output of device A is directly connected to an output or input of device B. It means that there exists a path between device A and device B which may be a path including other devices or means in between. Furthermore, “coupled to” does not imply direction. Hence, the expression “a device A is coupled to a device B” may be synonymous with the expression “a device B is coupled to a device A”. “Coupled” may mean that two or more elements are either in direct physical or electrical contact, or that two or more elements are not in direct contact with each other but yet still co-operate or interact with each other.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A system for automatically managing payments across multiple orders placed by multiple users associated with an ordering group, each user associated with a payment method, the system comprising:
a venue computing device coupled to a communications network, the venue computing device being associated with a venue; and
a database server coupled to the communications network, said database server adapted to:
store a user profile for each of said multiple users, each user profile storing at least one payment method for the respective user;
manage a list of multiple users associated with a shout, the database server including a scheduler adapted to sort the multiple users into an ordered list, based on an order in which the users joined the shout, said scheduler identifying in turn a current host responsible for a next order;
for each of a set of orders placed by said multiple users in said shout:
receive an order associated with the shout for products to be provided by the venue, the received order being associated with a current host;
charge said current host in accordance with a payment method associated with the user corresponding to the current host;
forward the received order associated with the shout to the venue computing device for completion by the venue;
update said list of multiple users to identify a next user in said list as a current host responsible for a next order; and
notify the current host that the order is ready, based on a communication from the venue.

2. The system according to claim 1, wherein said ordered list is stored as a circular linked list with a pointer identifying which of said users is the current host responsible for the next order.

3. The system according to claim 1, wherein notifying the current host that the order is ready includes:
sending a visual indication to a user computing device accessible by said current host.

4. The system according to claim 3, wherein said visual indication changes a region of a display screen of said user computing device to a predefined colour.

5. The system according to claim 4, wherein said visual indication flashes said predefined colour.

6. The system according to claim 1, wherein notifying the current host that the order is ready includes:
causing an audible notification to play from a user computing device accessible by said current host.

7. The system according to claim 1, wherein notifying the current host that the order is ready includes:
causing haptic feedback from a user computing device accessible by said current host, said haptic feedback including vibration of said user computing device.

8. The system according to claim 1, wherein said database server is further adapted to:
arrange payment to said venue based on said set of orders placed by said multiple users in said shout.

9. The system according to claim 1, further comprising:
a payment system for receiving payments from each of said users in accordance with a payment method associated with the respective user,
wherein the payment system arranges payment to said venue at a predefined time.

10. The system according to claim 1, wherein the payment method associated with each user is selected from the group consisting of: credit card, PayPal, escrow account, online bank wallet, and bank wallet stored in association with said database server.

11. The system according to claim 1, further comprising:
a user computing device on which executes a software application associated with the database server, said software application interacting with said database server to perform at least one of the following:
register a user with the database server;
login the user to the database server;
edit said stored user profile;
order drinks;
manage users associated with an ordering group;
manage an order associated with an ordering group;
create an individual shout for members of an ordering group;
create a group shout for members of an ordering group; or
create an Even Stevens shout for members of an ordering group, where each member of the shout will pay equally.

12. The system according to claim 11, wherein the software application executing on said user computing device manages an order associated with an ordering group by receiving an order input by one or more members of said ordering group and transmitting said order to said database server for transmittal to said venue.

13. The system according to claim 12, wherein the software application executing on said user computing device provides an input for receiving at least one of a table number, seat number, private lounge identifier, or private room identifier to accompany said order.

14. The system according to claim 11, wherein the software application executing on said user computing device utilises a geolocation device associated with said computing device to display a list of venues within the immediate proximity of the user.

15. A database server coupled to a communications network, said database server adapted to:
store a user profile for each of a plurality of registered users, each user profile storing at least one payment method for the respective user;
manage a list of multiple users associated with a shout, the database server including a scheduler adapted to sort the multiple users into an ordered list, based on an order in which the users joined the shout, said scheduler identifying in turn a current host responsible for a next order;
for each of a set of orders placed by said multiple users in said shout:
receive an order associated with the shout for products to be provided by a venue, the received order being associated with a current host;
charge said current host in accordance with a payment structure associated with that shout;
forward the received order associated with the shout to a venue computing device for completion by the venue;
update said list of multiple users to identify a next user in said list as a current host responsible for a next order; and
notify the current host that the order is ready, based on a communication from the venue.

16. The database server according to claim 15, wherein said payment structure charges the current host for that shout.

17. The database server according to claim 15, wherein said payment structure distributes the cost of that shout equally among all users associated with that shout.

18. The database server according to claim 15, wherein said payment structure distributes the cost of that shout equally among all users associated with that shout, except for any user designated as a VIP user.

19. The database server according to claim 15, further adapted to:
receive payments from said users associated with the shout, in accordance with the payment structure; and
distribute a portion of the received payments to the venue as payment for the received order.
